(19) United States
(12) Patent Application Publication
(10) Pub. No.: US 2010/0164920 A1
(43) Pub. Date: Jul. 1, 2010

(54) INFORMATION PROCESSING APPARATUS

(75) Inventor: Junko SHIMOHARADA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/568,565

(22) Filed: Sep. 28, 2009

(30) Foreign Application Priority Data
Dec. 26, 2008 (JP) 2008-334290

(51) Int. Cl. G09G 5/00

(52) U.S. Cl. 345/207; 345/204

(57) ABSTRACT

According to the invention, an information processing apparatus includes: a main body having a top face; a keyboard provided on the top face; an auxiliary illumination module provided on the top face not to overlap with the keyboard; a display unit connected to the main body by a hinge so as to be movable between a closed state and a open state, the display unit having a display face facing the top face at the open state; a display module provided on the display face; a plurality of imaging modules provided on the display face; a plurality of illuminating modules provided on the display face; a receiving module configured to receive video data via a network, the receiving module being housed in the main body; a display control module configured to let the display module display video based on the video data and local video based on local video data taken by at least one of the imaging devices.

### CROSS-REFERENCE TO RELATED APPLICATIONS

This application is based upon and claims the benefit of priority from Japanese Patent Application No. 2008-334290, filed Dec. 26, 2008, the entire contents of which are incorporated herein by reference.

### BACKGROUND

1. Field

The present invention relates to an information processing apparatus having cameras.

2. Description of the Related Art

Video chat is spreading in which the user has a chat over the Internet using video that is taken by a Web camera that is provided in a computer. A technique that makes it possible to adjust the position and angle of the Web camera freely is disclosed in Japanese Utility Model Registration No. 3,097,883, for example.

Adjusting the position etc. of a Web camera using the above technique takes time and labor because it is necessary for the user to move and adjust the Web camera each time. Furthermore, where a bendable tube that connects a Web camera and a computer is disposed in front on a display, it may become an obstruction to viewing of the display.

One desire of the user that relates to shooting is to determine his or her shot image freely by setting the shooting conditions in a detailed manner. Not only the shooting direction but also the illumination direction is an important shooting condition. If illumination is made in the same direction as the shooting direction, illumination light is reflected squarely by the face and a bright shot image is obtained. On the other hand, if illumination is made in a direction that is different from the shooting direction, a shot image with a shaded face is obtained. In the above-described technique in which a light is disposed in the vicinity of the camera, illumination is necessarily performed in the same direction as the shooting direction. Therefore, the above-described technique cannot satisfy the user's desire to determine his or her shot image freely by setting the shooting conditions in a detailed manner.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of a personal computer according to a first embodiment.

FIG. 2 is a block diagram showing the configuration of a signal processing system of the personal computer according to the first embodiment.

FIG. 3 shows a use situation of the personal computer according to the first embodiment.

FIG. 4 shows an example picture for setting shooting conditions in the first embodiment.

FIG. 5 is a flowchart of a procedure for setting shooting conditions in the first embodiment.

FIG. 6 is a perspective view of a personal computer according to the second embodiment.

FIG. 7 is a block diagram showing the configuration of a signal processing system of the personal computer according to the second embodiment

FIG. 8 shows an example picture for setting shooting conditions in the second embodiment.

FIG. 9 is a flowchart of a procedure for setting shooting conditions in the second embodiment.

### DETAILED DESCRIPTION

Various embodiments according to the invention will be described hereinafter with reference to the accompanying drawings. In general, according to one embodiment of the invention, an information processing apparatus includes: a main body having a top face; a keyboard provided on the top face; an auxiliary illumination module provided on the top face not to overlap with the keyboard; a display unit connected to the main body by a hinge so as to be movable between a closed state and a open state, the display unit having a display face facing the top face at the open state, and the top face being exposed when the display unit being set at the open state; a display module provided on the display face; a plurality of imaging modules provided on the display face not to overlap the display module; a plurality of illuminating modules provided on the display face not to overlap the display module and the imaging modules; a receiving module configured to receive video data via a network, the receiving module being housed in the main body; a display control module configured to let the display module display video based on the video data and local video based on local video data taken by at least one of the imaging devices.

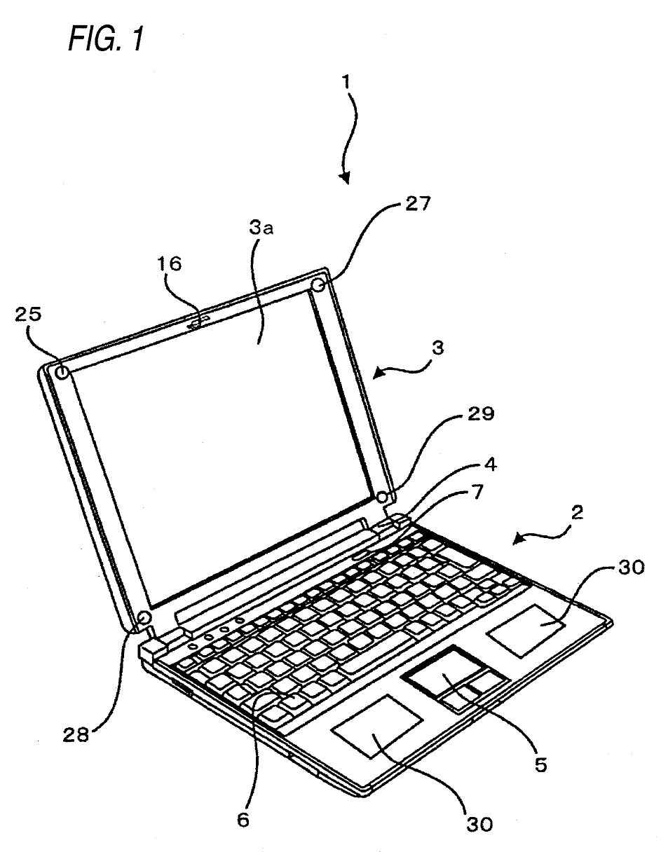

Embodiments of the present invention will be hereinafter described with reference to FIGS. 1-9 for a case that the invention is applied to a personal computer which is one type of information processing apparatus.

First, a first embodiment will be described with reference to FIGS. 1-5. FIG. 1 is a perspective view showing an appearance of a personal computer 1 according to the first embodiment. In this specification, the user side is defined as the front side and the side opposite to the user side is defined as the rear side. And the left side and the right side are defined as viewed from the user.

The personal computer 1 is composed of a computer main body 2 and a display unit 3. The display unit 3 incorporates a display device 3a and has a latch 16. The display unit 3 is attached to hinges 4 provided in a rear end portion of the computer main body 2 in such a manner as to rotate between a closed state where it covers the top surface of the computer main body 2 and an open state where it exposes the top surface of the computer main body 2. The computer main body 2 has a thin, box-shaped body and a central portion of the top surface of the body is provided with a keyboard 6. The top surface of a front-side body portion of the computer main body 2 is formed with a palm rest. A touch pad 5 is provided approximately at the center of the palm rest. The top surface of a rear-side body portion of the computer main body 2 is provided with a power switch 7 for powering on or off the computer main body 2. As shown in FIG. 1 in which the display unit 3 is at the open state, a first camera 25 and a second camera 27 are provided at the top-left corner and the top-right corner of the display unit 3, respectively. A first light 28 and a second light 29 are provided at the bottom-left corner and the bottom right corner of the display unit 3, respectively. The palm rest of the computer main body 2 is provided with palm rest lights 30.

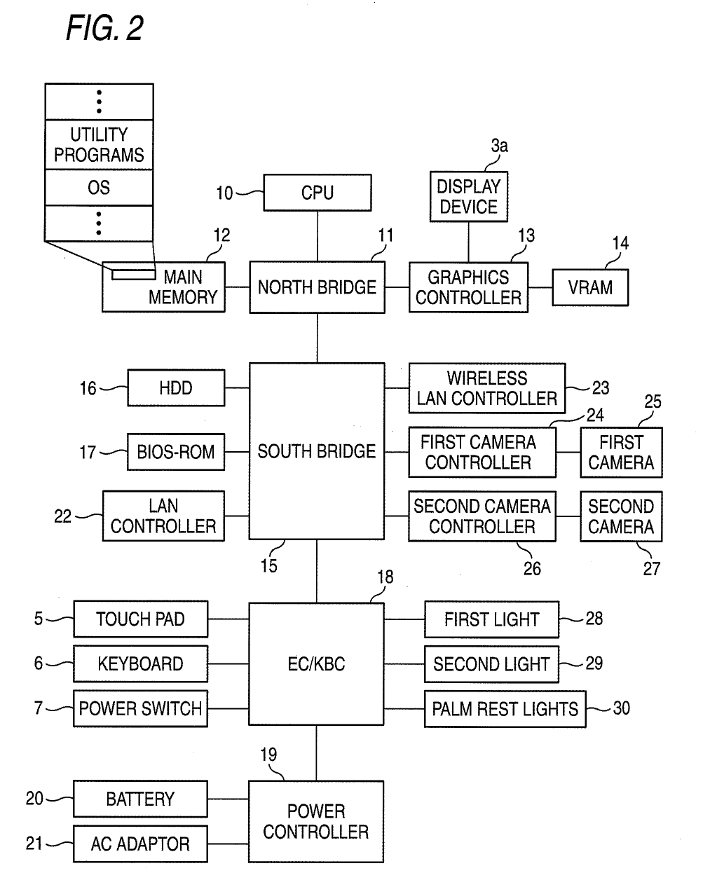

FIG. 2 is a block diagram showing the configuration of a signal processing system of the personal computer 1 according to the first embodiment. The personal computer 1 according to the first embodiment is equipped with the display device 3a, the touch pad 5, the keyboard 6, the power switch 7, a CPU (central processing unit) 10, a north bridge 11, a main memory 12, a graphics controller 13, a VRAM (video random access memory) 14, a south bridge 15, an HDD (hard disk drive) 16, a BIOS-ROM (basic input output system read-only memory) 17, an EC/KBC (embedded controller/keyboard controller) 18, a power controller 19, a battery 20, an AC adaptor 21, a LAN controller 22, a wireless LAN controller 23, a first camera controller 24, the first camera 25, a second camera controller 26, the second camera 27, the first light 28, the second light 29, and the palm rest lights 30.

The display device 3a displays video on the basis of a video signal that is supplied from the graphics controller 13.

The touch pad 5 and the keyboard 6 are manipulation devices for sending various manipulation signals to the personal computer 1 according to user manipulations.

The power switch 7 sends a control signal for powering on or off the personal computer 1 according to a user manipulation.

The CPU 10, which is a processor provided for controlling operation of the personal computer 1, runs an operating system and various application programs which are loaded into the main memory 12 from the HDD 16. The CPU 10 loads, into the main memory 12, a system BIOS that is stored in the BIOS-ROM 17, and runs it. The system BIOS is a program for hardware control.

The north bridge 11 is a bridge device for connecting a local bus of the CPU 10 and the south bridge 15. The north bridge 11 incorporates a memory controller for access-controlling the main memory 12. The north bridge 11 has a function of communicating with the graphics controller 13 via an AGP (accelerated graphics port) bus or the like.

The main memory 12 is what is called a working memory for development of the operating system and the various application programs stored in the HDD 16 and the system BIOS stored in the BIOS-ROM 17.

The graphics controller 13 is a display controller for controlling the display device 3a which is used as a display monitor of the personal computer 1. The graphics controller 13 generates a video signal for forming a display image to be displayed on the display device 3a on the basis of display data that is drawn on the VRAM 14 according to the operating system and an application program. The video signal generated by the graphics controller is output to the line.

The south bridge 15 is connected to various devices including the LAN controller 22 and the wireless LAN controller 23 for exchanging data with devices connected to a network. The south bridge 15 controls access to the BIOS-ROM 17 and controls disc drives (I/O devices) such as the HDD 16 and an ODD (optical disc drive). Furthermore, in the embodiment, the south bridge 15 is connected to the first camera controller 24 and the second camera controller 26.

The HDD 16 is a storage device for storing the operating system and the various application programs.

The BIOS-ROM 17 is a rewritable nonvolatile memory for storing the system BIOS which is a program for hardware control.

The EC/KBC 18 controls the touch pad 5 and the keyboard 6 which are input means.

The EC/KBC 18 is a one-chip microcomputer for monitoring and controlling various devices (peripheral devices, sensors, a power circuit, etc.) irrespective of the system condition of the personal computer 1. The EC/KBC 18 has a function of cooperating with the power controller 19 to power on or off the personal computer 1 in response to a user manipulation on the power switch 7.

The power controller 19 generates system power to be supplied to the individual components (computer main body 2 and the display unit 3) of the personal computer 1 using external power when it is supplied via the AC adaptor 21. The power controller 19 generates system power to be supplied to the individual components of the personal computer 1 using the battery 20 when no external power is supplied via the AC adaptor 21.

The LAN controller 22 and the wireless LAN controller 23 are network controllers (communication devices) for exchanging data with devices connected to a network. During a video chat, the LAN controller 22 or the wireless LAN controller 23 sends out video that is taken by the personal computer 1 and receives video that is sent from the other party.

The first camera controller 24 and the second camera controller 26 control the first camera 25 and the second camera 27, respectively.

The first camera 25 and the second camera 27 perform shooting.

The first light 28 and the second light 29 emit light from light sources to illuminate a region in front of the display device 3a. They are controlled by the EC/KBC 18.

The palm rest lights 30 emit light from light sources to illuminate a region above the computer main body 2. An example of each light source is an LED (light-emitting diode).

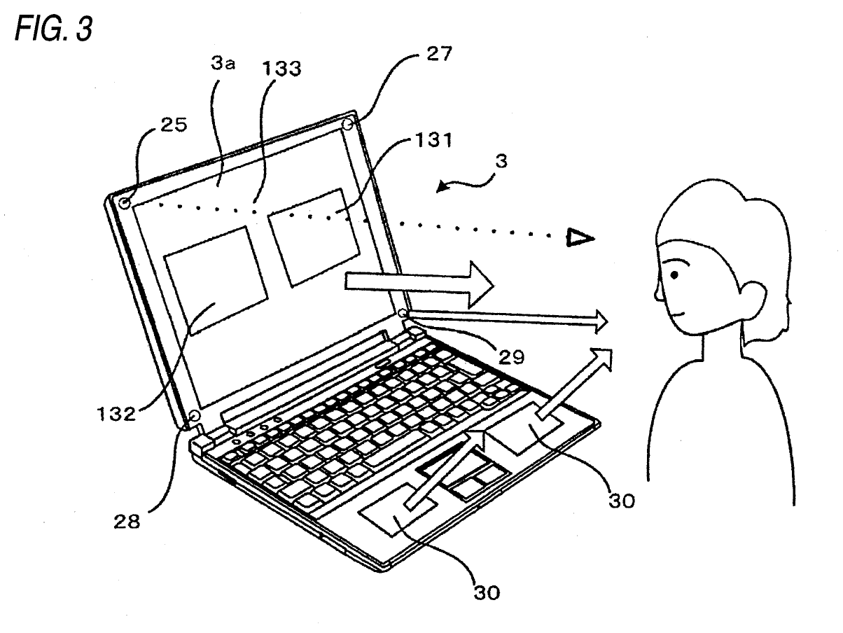

Next, a situation of use of the personal computer 1 having the above configuration will be described. FIG. 3 shows a use situation of the personal computer 1 according to the first embodiment.

First, the user can choose a camera to be used for shooting from the first camera 25 and the second camera 27 which are located on the left side and the right side, respectively. Usually, humans tend to chew mainly using the left or right portions of the jaws, as a result of which human faces are not symmetrical with respect to the vertical center line. More specifically, the portions of the jaws that are used more frequently to chew develop more than the other portions. It is therefore considered that, in general, humans look leaner when shot from the side of the portions of the jaws that are used less frequently to chew. As such, users have a shooting-related taste that they prefer the left side or right side of their faces as an option for attaining a better shot image. Whereas a conventional Web camera is usually disposed at the top center of the display unit, the invention can accommodate such a taste of the user by allowing the user to choose between the cameras 25 and 27 which are disposed on the left side and the right side.

Next, the user can choose a light to be used for illumination from the first light 28 and the second light 29 which are located on the left side and the right side, respectively. Assume here that the first camera 25 (left-side camera) is chosen as shown in FIG. 3. In this case, if the first light 28 is chosen, illumination is made from the same side (left side) as the shooting side and a bright face image is taken by the first camera 25 because the light is reflected squarely by the face. On the other hand, if the second light 29 is chosen, illumination is made from the right side that is opposite to the shooting side and hence a shaded face image is taken by the first camera 25.

Further illumination with the palm rest lights 30 enables shooting under brighter illumination by applying stronger light to the face. That is, illumination with the palm rest lights 30 in addition to the first light 28 or the second light 29 enables a video chat even in a situation that the user is located in a dark-illuminated room.

A shot image display picture 131 of an image of the user himself or herself taken by the first camera 25 or the second camera 27 and a received image display picture 132 of an image of a person on the other side received over a network are displayed on the display device 3a. The area of the screen of the display device 3a other than the areas where the shot image display picture 131 and the received image display picture 132 are displayed is a display color changeable area 133. The user can select a display color of the display color changeable area 133. That is, the impression of a shot image of the user taken by the camera can be changed by the manner of reflection, by the user face, of light that is emitted from the display color changeable area 133. For example, if the color of light emitted from the display color changeable area 133 is a warm color, a healthy shot image is produced. If it is a cold color, a refreshing shot image is produced. If it is white, a shot image in which blemishes and wrinkles are less conspicuous is produced.

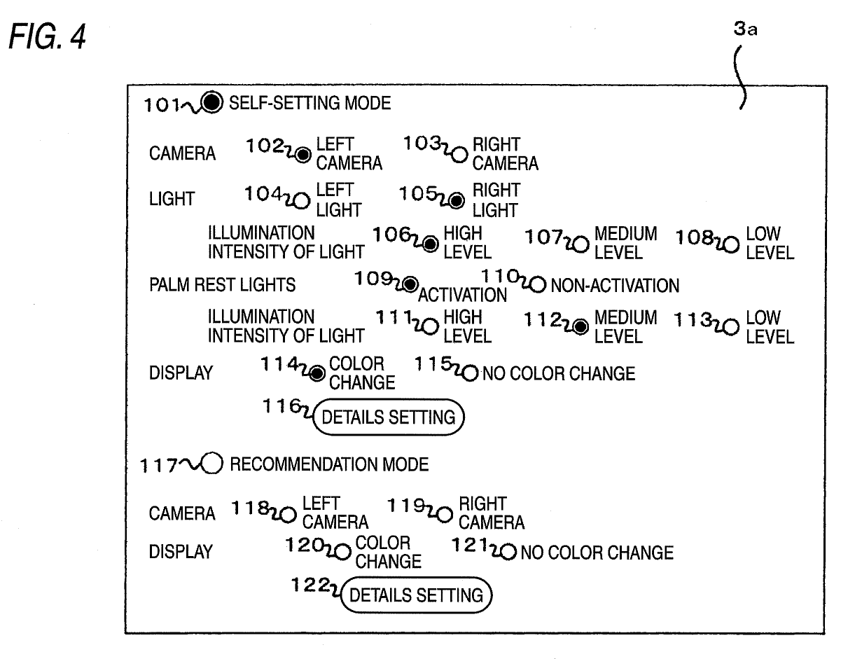

Next, a procedure for setting shooting conditions in the first embodiment will be described. FIG. 4 shows an example picture for setting shooting conditions in the first embodiment. A selection picture as shown in FIG. 4 is presented to the user to prompt the user to set individual items. A radio button 101 for choosing a self-setting mode and a radio button 117 for choosing a recommendation mode are provided. The radio buttons 101 and 117 can be chosen exclusively. The self-setting mode which is chosen in FIG. 1 will be described in the first embodiment. The recommendation mode will be described in the second embodiment.

As for the choice between the cameras 25 and 27, a radio button 102 for choosing the first camera (left camera) 25 and a radio button 103 for choosing the second camera (right camera) 27 can be chosen exclusively.

Although in this embodiment only one camera is chosen as a camera to be used for shooting, the invention is not limited to such a case. That is, shooting may be performed by using both cameras 25 and 27, in which case images taken by the respective cameras 25 and 27 are displayed on the display device 3a. The images taken by the respective cameras may be displayed on the display device 3a by switching an image to be displayed on the display device 3a at 5-sec to 10-sec interval.

As for the choice between the lights 28 and 29, a radio button 104 for choosing the first light (left light) 28 and a radio button 105 for choosing the second light (right light) 29 can be chosen exclusively.

Radio buttons 106-108 are for selecting illumination intensity, that is, the quantity of light to be emitted from the light chosen, to be employed when the radio button 104 or 105 is chosen. The radio button 106 is for selecting high-level illumination with the light chosen. The radio button 107 is for selecting medium-level illumination. The radio button 108 is for selecting low-level illumination. The high level, the medium level, and the low level mean the largest light quantity level, the middle light quantity level, and the smallest light quantity level, respectively, when the light quantity level of the light is divided into three levels.

Although in this embodiment only one light is chosen as a light to be used for illumination, the invention is not limited to such a case. That is, shooting may be performed by using both lights 28 and 29, in which case the illumination intensity of each light is made selectable.

As for the palm rest lights 30, a radio button 109 for choosing activation of the palm rest lights 30 and a radio button 110 for choosing non-activation of the palm rest lights 30 can be chosen exclusively.

Radio buttons 111-113 are for selecting illumination intensity to be employed when the radio button 109 is chosen. The radio button 111 is for selecting high-level illumination with the palm rest lights 30. The radio button 112 is for selecting medium-level illumination. The radio button 113 is for selecting low-level illumination. The meanings of the illumination intensity levels of the palm rest lights 30 are the same as those of the lights 28 and 29.

As for the display color of the display color changeable area 133, a radio button 114 for choosing a color change and a radio button 115 for choosing no color change can be chosen exclusively. If the radio button 114 is chosen, a details setting button 116 is rendered manipulatable. If the details setting button 116 is manipulated, a color list is displayed to allow the user to select a display color of the display color changeable area 133. If the details setting button 116 is not manipulated, a default color is selected.

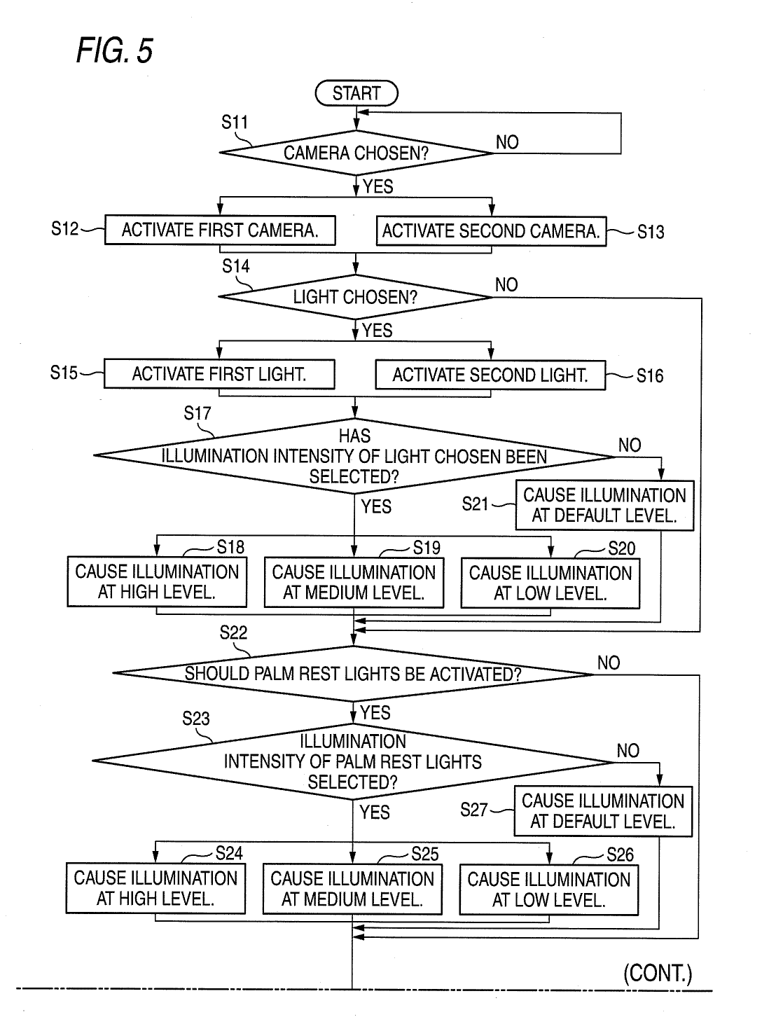

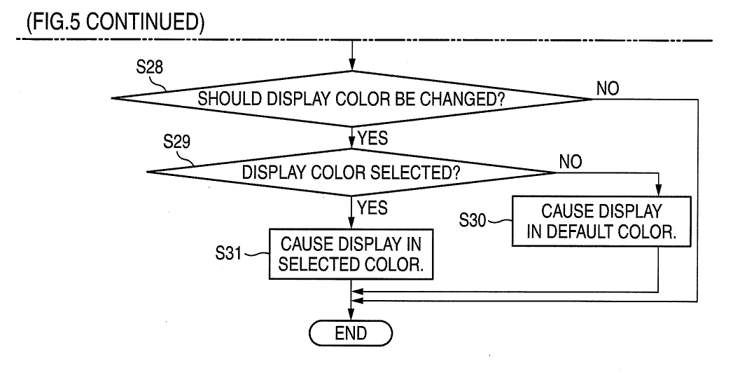

FIG. 5 is a flowchart of a procedure for setting shooting conditions in the first embodiment. The following procedure is performed as a setting-related application which is stored in the HDD 16 is run by the CPU 10. Information relating to various initial settings is also stored in the HDD 16. The following description assumes a case that items are selected as shown in FIG. 4.

First, at step S11, the CPU 10 judges whether an input relating camera choice has been made through the manipulation devices. If judging that no input relating camera choice has been made (S11: no), the CPU 10 refrains from executing the subsequent steps until an affirmative judgment is made. On the other hand, if judging that an input relating camera choice has been made (S11: yes), at step S12 the CPU 10 activates the first camera 25 if the input is to choose the first camera 25. At step S13, the CPU 10 activates the second camera 27 if the input is to choose the second camera 27. In the example of FIG. 4, the radio button 102 is chosen and hence the first camera (left camera) 25 is activated.

At step S14, the CPU 10 judges whether an input relating light choice has been made. If judging that no such input has been made (S14: no), the CPU 10 moves to step S22 (described later). On the other hand, if judging that an input relating light choice has been made (S14: yes), at step S15 the CPU 10 activates the first light 28 if the input is to choose the first light 28. At step S16, the CPU 10 activates the second light 29 if the input is to choose the second light 29. In the example of FIG. 4, the radio button 105 is chosen and hence the second light (right light) 29 is activated.

At step S17, the CPU 10 judges whether an input relating to selection of illumination intensity of the light chosen has been made. If judging that no such input has been made (S17: no), at step S21 the CPU 10 causes illumination at the default level. On the other hand, if judging that an input for selecting the high level has been made (S17: yes), at step S18 the CPU 10 causes illumination at the high level. If judging that an input for selecting the medium level has been made (S17: yes), at step S19 the CPU 10 causes illumination at the medium level. If judging that an input for selecting the low level has been made (S17: yes), at step S20 the CPU 10 causes illumination at the low level. In the example of FIG. 4, the radio button 106 is selected and hence illumination is performed at the high level by the second light 29.

At step S22, the CPU 10 judges whether an input for activating the palm rest lights 30 has been made. If judging that no such input has been made (S22: no), the CPU 10 moves to step S28 (described later). On the other hand, it judging that an input for activating the palm rest lights 30 has been made (S22: yes), the CPU 10 judges at step S23 whether an input relating to illumination intensity of the palm rest lights 30 has been made. In the example of FIG. 4, the radio button 106 is chosen and hence the palm rest lights 30 are activated.

If it is judged that no such input has been made (S23: no), at step S27 the CPU 10 causes illumination at the default level. On the other hand, if judging that an input for selecting the high level has been made (S23: yes), at step S24 the CPU 10 causes illumination at the high level. If judging that an input for selecting the medium level has been made (S23: yes), at step S25 the CPU 10 causes illumination at the medium level. If judging that an input for selecting the low level has been made (S23: yes), at step S26 the CPU 10 causes illumination at the low level. In the example of FIG. 4, the radio button 112 is selected and hence illumination is performed at the medium level by the palm rest lights 30.

At step S28, the CPU 10 judges whether an input to the effect that the display color of the display color changeable area 133 should be changed has been made. If judging that no such input has been made (S28: no), the CPU 10 finishes the photographing conditions setting procedure. On the other hand, if judging that an input to the effect that the display color of the display color changeable area 133 should be changed has been made (S28: yes), the CPU 10 judges at step S29 whether an input for selecting a display color of the display color changeable area 133 has been made. In the example of FIG. 4, the radio button 114 is chosen and hence the display color of the display color changeable area 133 is changed.

If judging that no input for selecting a display color of the display color changeable area 133 has been made (S29: no), at step S30 the CPU 10 causes display in the default color. On the other hand, if judging that an input for selecting a display color of the display color changeable area 133 has been made (S29: yes), at step S31 the CPU 10 causes display in the display color changeable area 133 in the selected color. In the example of FIG. 4, the radio button 114 is chosen and hence the details setting button 116 is manipulatable and it is possible to select a display color of the display color changeable area 133 from the color list table. If no color is selected, display is performed in the default color. As described above, the impression of a shot image of the user can be changed by changing the display color of the display color changeable area 133.

The detailed settings selected according to the above procedure can be stored in the HDD 16. Storing shooting conditions once set makes it possible to reproduce the shooting conditions that conform to the user's tastes.

As described above, according to the first embodiment, since choice can be made from the plural cameras 25 and 27, shooting can be performed from a position that conforms to the user's taste without taking time and labor to move the camera setting position. Performing illumination by the light 28 or 29 and the palm rest lights 30 makes it possible to provide a light quantity that is necessary for shooting irrespective of the use situation of the personal computer 1. Shooting conditions can be set in a detailed manner by making changeable the display color of the area other than the video chat pictures and thereby changing the impression of a shot image of the user. Furthermore, storing settings makes it possible to immediately reproduce shooting conditions that conform to the user's tastes.

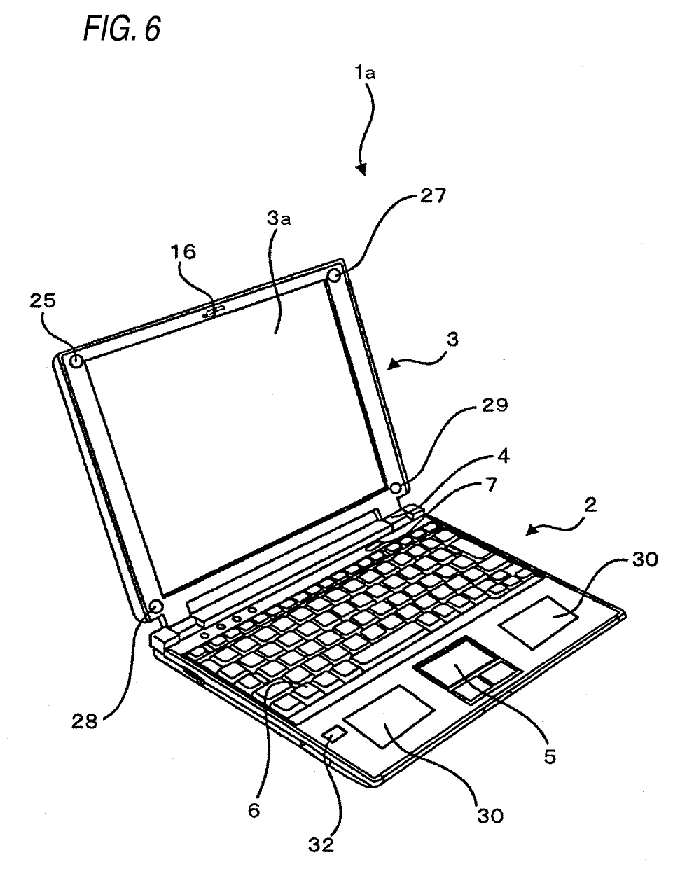

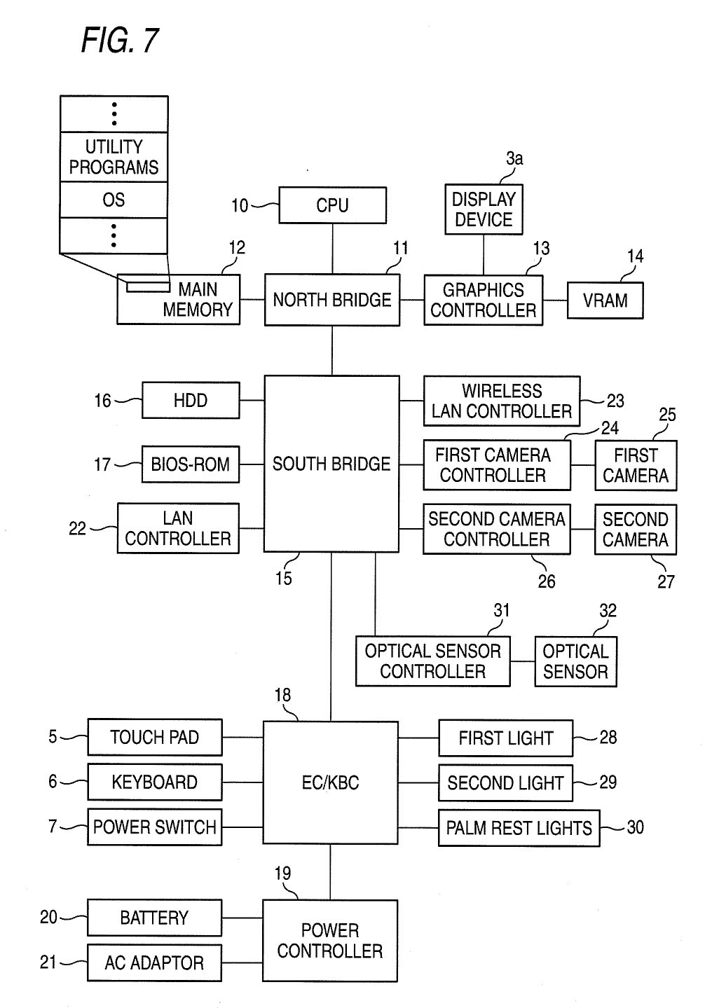

Next, a second embodiment will be described with reference to FIGS. 6-9. FIG. 6 is a perspective view showing an appearance of a personal computer 1a according to the second embodiment. FIG. 7 is a block diagram showing the configuration of a signal processing system of the personal computer 1a according to the second embodiment. Components having the same components in the personal computer 1 according to the first embodiment (see FIGS. 1 and 2) are given the same reference symbols as the latter. The second embodiment is different from the first embodiment in that an optical sensor controller 31 and an optical sensor 32 are added. The optical sensor controller 31 is connected to the south bridge 15 and controls the optical sensor 32. The optical sensor 32 is provided on the palm rest and detects a light quantity of ambient illumination.

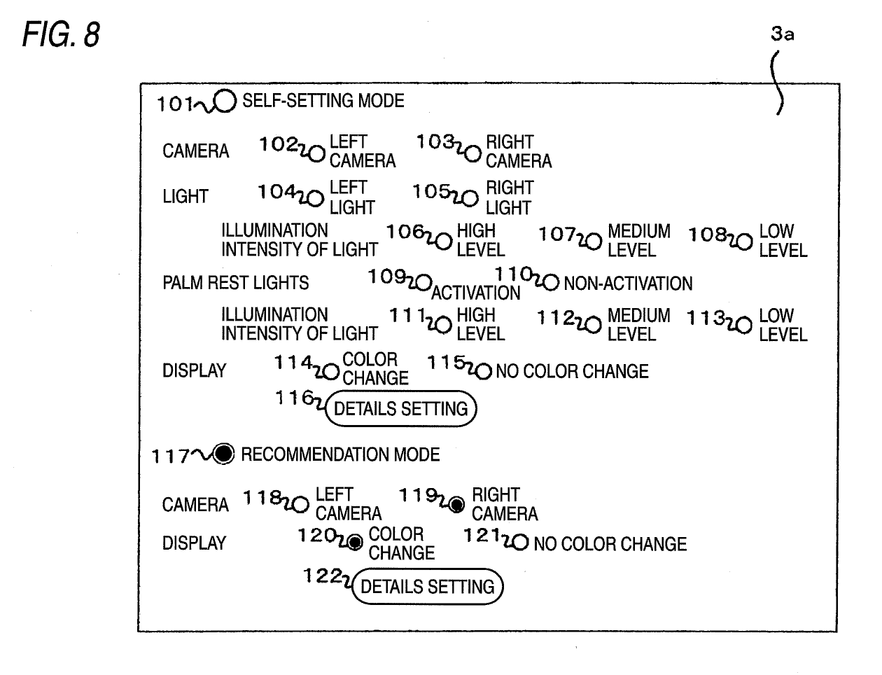

Next, a procedure for setting shooting conditions in the second embodiment will be described. FIG. 8 shows an example picture for setting shooting conditions in the second embodiment. The second embodiment is directed to the recommendation mode which is chosen by the radio button 117.

In the recommendation mode, first, a camera to be used for shooting is chosen. A radio button 118 for choosing the first camera (left camera) 25 and a radio button 119 for choosing the second camera (right camera) 27 can be chosen exclusively.

In the recommendation mode, choice of a light to be used for illumination, choice as to whether to activate the palm rest lights 30, and selection of illumination intensity of a light chosen and the palm rest lights 30 are made on the basis of a detection result of the optical sensor 32. How individual items are set on the basis of a detection result will be described later.

As for the display color of the display color changeable area 133, a radio button 120 for choosing a color change and a radio button 121 for choosing no color change can be chosen exclusively. If the radio button 120 is chosen, a details setting button 122 is rendered manipulatable. If the details setting button 122 is manipulated, a color list is displayed to allow the user to select a display color of the display color changeable area 133. If the details setting button 122 is not manipulated, a default color is selected.

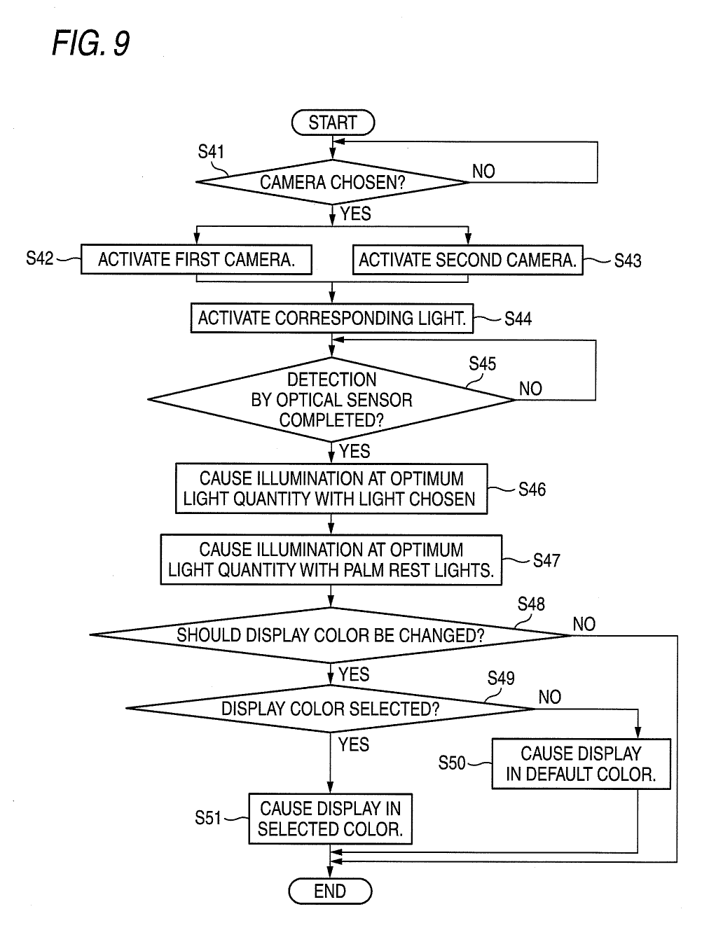

FIG. 9 is a flowchart of a procedure for setting shooting conditions in the second embodiment. The following procedure is performed as a setting-related application which is stored in the HDD 16 is run by the CPU 10. The following description assumes a case that items are selected as shown in FIG. 8.

First, at step S41, the CPU 10 judges whether an input relating camera choice has been made through the manipulation devices. If judging that no input relating camera choice has been made (S41: no), the CPU 10 refrains from executing the subsequent steps until an affirmative judgment is made. On the other hand, if judging that an input relating camera choice has been made (S41: yes), at step S42 the CPU 10 activates the first camera 25 if the input is to choose the first camera 25. At step S43, the CPU 10 activates the second camera 27 if the input is to choose the second camera 27. In the example of FIG. 8, the radio button 119 is chosen and hence the second camera (right camera) 25 is activated.

At step S44, a light corresponding to the chosen camera is activated. The corresponding light is the light that is diagonally opposite to the chosen camera and is described in the application stored in the HDD 16. That is, shooting that provides desirable shades is realized by performing illumination from the side that is different from the camera shooting side rather than from the same side. In the example of FIG. 8, since the first light (left light) 28 is activated because the second camera (right camera) 27 is chosen.

At step S45, the CPU 10 judges whether light quantity detection by the optical sensor 32 has been completed. If judging that light quantity detection has not been completed yet (S45: no), the CPU 10 refrains from executing the subsequent steps until an affirmative judgment is made. On the other hand, if judging that light quantity detection has been completed (S45: yes), at step S46 the CPU 10 causes the light chosen to emit light at an optimum light quantity on the basis of the detection result. More specifically, the CPU 10 sends information relating to the optimum light quantity to the EC/KBC 18 and thereby causes the light chosen to emit light at that light quantity. The optimum light quantity is determined on the basis of a light quantity that is described in the setting-related program stored in the HDD 16 as being necessary for ordinary shooting. That is, the optimum light quantity of illumination to be performed by the light chosen is determined by subtracting the detected light quantity from the light quantity that is necessary for ordinary shooting.

At step S47, the CPU 10 causes the palm rest lights 30 to emit light at an optimum light quantity on the basis of the detection result. More specifically, the CPU 10 causes illumination with the palm rest lights 30 if the light quantity that was set at step S46 for the light chosen does not satisfy the light quantity that is necessary for ordinary shooting. More specifically, the CPU 10 sends information relating to the optimum light quantity to the EC/KBC 18 and thereby causes illumination with the palm rest lights 30.

At step S48, the CPU 10 judges whether an input to the effect that the display color of the display color changeable area 133 should be changed has been made. If judging that no such input has been made (S48: no), the CPU 10 finishes the photographing conditions setting procedure. On the other hand, if judging that an input to the effect that the display color of the display color changeable area 133 should be changed has been made (S48: yes), the CPU 10 judges at step S49 whether an input for selecting a display color of the display color changeable area 133 has been made. In the example of FIG. 8, the radio button 120 is chosen and hence the display color of the display color changeable area 133 is changed.

If judging that no input for selecting a display color of the display color changeable area 133 has been made (S49: no), at step S50 the CPU 10 causes display in the default color. On the other hand, if judging that an input for selecting a display color of the display color changeable area 133 has been made (S49: yes), at step S51 the CPU 10 causes display in the display color changeable area 133 in the selected color. In the example of FIG. 8, the radio button 120 is chosen and hence the details setting button 116 is manipulatable and it is possible to select a display color of the display color changeable area 133 from the color list table. If no color is selected, display is performed in the default color. As described above, the impression of a shot image of the user can be changed by changing the display color of the display color changeable area 133.

As described above, according to the second embodiment, the user is only required to choose a camera to be used for shooting and the other shooting conditions are set automatically. Furthermore, the illumination device(s) of each kind can perform illumination at a level that is necessary for shooting by detecting an ambient illumination state of a use situation with the optical sensor 32. In contrast to the first embodiment, recommendable shooting conditions for a good shot image can be realized without taking time and labor to make settings for the light 25 or 27 and the palm rest lights 30.

The invention is not limited to the above embodiments themselves and, in the practice stage, various modifications are possible without departing from the spirit and scope of the invention.

As described with reference to the embodiment, there is provided an information processing apparatus capable of realizing shooting conditions that conform to the user's tastes.

The embodiment provide shooting conditions that conform to the user's tastes.

What is claimed is:

1. An information processing apparatus comprising:
a main body comprising a top face;
a keyboard on the top face;
an auxiliary illumination module on the top face and the outside of the keyboard;
a display connected to the main body by a hinge and configured to move between a closed state and a open state, the display comprising a display face facing the top face at the closed state, and the top face being exposed when the display is set at the open state;
a display module on the display face;
a plurality of imaging modules on the display face and the outside of the display module;
a plurality of illuminating modules on the display face and the outside of the display module and the imaging modules;
a receiver in the main body, configured to receive video data via a network;
a display controller configured to control the display module to display video based on the received video data and local video based on local video data taken by at least one of the imaging devices.

2. The apparatus of claim 1, wherein the display comprises a longitudinal first side and a longitudinal second side connected to the hinge,
the imaging modules are in the vicinity of first and second ends of the longitudinal first side, and
the illumination modules are in the vicinity of first and second ends of the second side.

3. The apparatus of claim 1 further comprising:
an imaging module selecting module configured select at least one imaging module configured to record the local video; and
an illumination module selecting module configured to select at least one illumination module to illuminate.

4. The apparatus of claim 3 further comprising a storage module configured to store relation information between the imaging modules and the illumination modules, wherein
the illumination module selecting module is configured to select one illumination module corresponding to a selected imaging module in the relation information when the imaging module setting module selects the imaging module.

5. The apparatus of claim 4 further comprising an illumination intensity setting module configured to set illumination intensity of at least one of the auxiliary illumination module and the selected illumination module.

6. The apparatus of claim 5 further comprising:
an optical sensor configured to detect a light intensity of ambient illumination; and
an optical sensor controller configured to control illumination intensity of at least one of the auxiliary illumination module and the selected illumination module according to a detected result of the optical sensor.

7. The apparatus of claim 6 further comprising a display color setting module configured to set a color of an area of a screen of the display module outside of areas where the video and the local video are displayed.
